(19) United States
(12) Patent Application Publication
(10) Pub. No.: US 2002/0024929 A1
(43) Pub. Date: Feb. 28, 2002

(54) Network and coupling device for connecting two segments in a network

(76) Inventors: Dieter Brueckner, Unterleiterbach (DE); Peter Ochsenreither, Berg (DE); Juergen Seiter, Baden-Baden (DE); Michael Tremel, Nuernberg (DE)

Correspondence Address: SUGHRUE, MION, ZINN, MACPEAK & SEAS, PLLC, 2100 PENNSYLVANIA AVENUE, N.W., WASHINGTON, DC, 20037-3213, US

(21) Appl. No.: 09/812,570

(22) Filed: Mar. 21, 2001

Related U.S. Application Data
(63) Continuation of application No. PCT/DE99/03041, filed on Sep. 22, 1999.
(63) Continuation of application No. PCT/DE99/03038, filed on Sep. 22, 1999.

(30) Foreign Application Priority Data
Sep. 22, 1998 (DE) 198 43 447.2
Sep. 22, 1998 (DE) 198 43 449.9

(51) Int. Cl. H04L 12/437

(52) U.S. Cl. 370/222; 370/258; 370/452

(57) ABSTRACT

A network and a coupling device for connecting two segments in such a network. The coupling device has means (510 for measuring the slot time configured in the users by means of so-called GAP queries with which active users (201 . . . 206) using the PROFIBUS DP protocol for data transmission cyclically check whether new users have been connected to the network. Based on this slot time, coupling devices obtain information on the extent of the network, which is required for certain monitoring mechanisms. Further, a network and a coupling device for connecting segments in such a network, which has means (63, 64, 73, 78) for detecting corruption of a message by faults on a segment (16) and blocking the onward transmission of messages received on the faulty segment (16). The coupling devices (22, 23) connected to the faulty segment (16) block and reauthorize onward transmission almost simultaneously so that no unidirectional connection is established.

This is a Continuation of International Applications PCT/DE99/03041 and PCT/DE99/03038, each with an international filing date of Sep. 22, 1999, the disclosures of which are incorporated into this application by reference.

### FIELD OF AND BACKGROUND OF THE INVENTION

The invention relates to a network and to a coupling device for connecting two segments in a network.

Networks in which a plurality of users is interconnected for data transmission are generally known in the art. Since a network with only a single bus is limited with respect to the number of users and bus length by physical factors and logical determinations, the network is divided into several segments that are interconnected via coupling devices, also referred to as repeaters. A coupling device is connected to the bus segments on either side by means of a transceiver each and essentially serves for bidirectional signal regeneration between the two segments. To secure the data transmission, it is known, for example from the rtp-seminar “Bus Systems” in “Regelungstechnische Praxis,” 1984, Volume 2, pp. S5 to S8, to provide messages with control information. A user sending the message into the network adds this control information to the message, while another user receiving the message compares it with self-generated control information and, in case of a mismatch, detects a transmission error. One possibility of providing this control information, as cited in this document, is a CRC (Cyclic Redundancy Check) word, which is formed over the entire message. Any fault in a segment of the network leads to faulty messages being received, which the receiver can detect as faulty messages by means of the control information.

Sporadic errors on a segment, which simulate the transmission of a message, are also forwarded to all other segments of the network just like faulty messages. Faults thus propagate in the entire network and under some circumstances may take up a large portion of the transmission capacity. In the worst case the entire network may be blocked by interference on a segment.

To be able to use certain monitoring mechanisms that make it possible specifically to decouple faulty segments from the network, information on the extent of the network is required in the coupling devices.

### OBJECTS OF THE INVENTION

One object of the invention is to create a network and a coupling device for connecting two segments in a network, in which the coupling device can readily obtain information on the extent of the network.

A further object of the invention is to create a network and a coupling device for connecting two segments in such a network, through which the influence of faults on the capacity of the network is reduced.

### SUMMARY OF THE INVENTION

To attain these and other objects, according to one formulation of the invention, the new network is divided into several segments interconnected by at least one coupling device. The coupling device has means for measuring the predefined slot time in the users by means of so-called GAP queries with which the active users using the PROFIBUS DP protocol for data transmission cyclically check whether new users have been connected to the network, wherein the slot time is the time for which an active user waits after a GAP query for a reply message from a polled user. The new coupling device has means for measuring the predefined slot time in the users by means of so-called GAP queries with which active users using the PROFIBUS DP protocol for data transmission cyclically check whether new users have been connected to the network, wherein the slot time is the time for which an active user waits after a GAP query for a reply message from a polled user.

According to a further formulation of the invention, the network is divided into at least three segments with bidirectional data transmission. A first segment and a second segment are interconnected by a first coupling device. The second segment and a third segment are interconnected by a second coupling device. The first coupling device has means for detecting corruption of a message through faults on the second segment and, after detection of an error, blocking the forwarding of messages received on the second segment to the first segment. Furthermore, the second coupling device has means for blocking the forwarding of messages received on the second segment to the third segment upon detection of a block of the forwarding of messages by the first coupling device.

The invention offers the advantage that coupling devices are capable of independently measuring during operation of the network the slot time which is parameterized in the users and contains direct information on the extent of the network. The coupling devices can readily deduce from this information at which point in time after a poll message with acknowledge no messages remain in the network. Since the coupling device automatically records information regarding the extent of the network, a corresponding parameterization of the coupling device is not required when the network is configured.

The slot time measurements may be frequently repeated so that the coupling devices quickly respond to changes in the extent of the network if at least one active user is configured so that it cyclically executes GAP queries to a non-existent user.

Advantageously, the slot time configured in the users amounts to at least twice the time that elapses at maximum in an optical double ring between sending a GAP query message and receiving a reply message. Thus the slot time is also adhered to in an optical line, which is produced when a segment is decoupled from an optical double ring.

Blocking of the forwarding of messages from a faulty segment has the advantage that dynamic faults, e.g., short spikes, as well as continuous disturbances in a segment of the network do not reduce the transmission capacity of other segments of said network. Segmentation, in which the forwarding of faulty messages from a faulty segment to neighboring segments is blocked, is a simple way to prevent the propagation of faults over several segments.

The invention has the further advantage that dynamic interference, e.g., short spikes, as well as continuous disturbances coupled into a segment of a network do not negatively affect the transmission capacity of other segments of the same network. Segmentation, in which the forwarding of faulty messages from a faulty segment to neighboring segments is blocked, is a simple way to prevent the propagation of faults over several segments.

In addition, when there is a fault in one transmission direction of a segment, the invention advantageously prevents the creation of a unidirectional connection in that segment. When a segment is decoupled, which prevents messages from the rest of the network from being received in the network segment on the one side of the faulty segment, data traffic forms on this network segment, which is asynchronous to the data traffic in the rest of the network, i.e., the network segment on the other side of the faulty segment. A unidirectional connection via the faulty segment would transmit the data traffic from the network segment on the one side of the faulty segment to the rest of the network and, in the extreme case, would destroy the data traffic in the rest of the network. This would mean a substantial limitation of the capacity of the network. The invention thus prevents collisions of messages sent by users, who no longer hear anything of the transmission activity of other users due to a faulty segment, with the messages of the users of the rest of the network. Network segments are created on either side of the faulty segment in which data transmission can take place independently. Data transmission can thus be maintained in both of these network segments despite the faulty segment.

If a coupling device, after detecting a fault in one segment, no longer sends any messages to the faulty segment for a predefined period of time, another coupling device located in the faulty segment can readily detect, by monitoring the transmission activities in the second segment, that the one coupling device has blocked the forwarding of messages and a fault has been detected in the segment. To avoid a unidirectional connection, the other coupling device immediately thereafter can also block the forwarding of messages received in the faulty segment. A special signal by which one coupling device informs the other of the blocking of the forwarding of messages received in the faulty segment is thus not required.

To ensure that a segment is not disconnected from the network due to isolated sporadic faults, it is possible that the forwarding of messages is prevented only after a predefined number of faulty messages has been ascertained.

A particularly simple-to-use monitoring mechanism is obtained if the means for detecting a corrupted message are designed such that an error is detected if a signal level in a received message persists longer than a predefined period of time. This advantageously utilizes the fact that in all transmission protocols for networks the levels must change after a certain time.

This monitoring mechanism is particularly advantageous in PROFIBUS DP in that an error is detected if the signal level in a received message remains on a low level for 13 consecutive bit times. In PROFIBUS DP such a character can never occur due to the high-level stop bit in the undisturbed case. Consequently the corruption must be due to a fault.

Another easy-to-use monitoring mechanism compares the number of characters contained in a received message with a predefined maximum number. The number of characters in a message is limited in practically all transmission protocols and can thus be checked for a predefined limit value. The PROFIBUS DP protocol, in particular, permits only messages of a maximum of 255 characters, so that a message with more than preferably 262 characters can occur only in case of a fault.

Additional control information, which a first coupling device forwarding a message from a first segment to a second segment adds to a message transmitted to the second segment irrespective of whether any control information valid on the first segment is present, and which can thus be checked by a second coupling device connected to the second segment, has the advantage that it permits unambiguous localization of the error location up to the faulty segment.

The message can be supplemented by control information irrespective of the transmission protocol used on other segments. Even messages transmitted on the first segment without complex control information, for instance only with a parity bit, as is the case in PROFIBUS DP, are supplemented by additional control information on the second segment to increase transmission security. Such monitoring of the transmission quality detects faulty messages, which can then be excluded from further processing. In non-storing coupling devices, which directly forward received messages on the opposite segment, the addition of control information to the message presumes a transmission pause between two messages which is greater than the time required to transmit the control information. Since there are always transmission pauses between messages, this condition is readily met.

Advantageously, the control information can be generated at the same time as the message is received, if a CRC (Cyclic Redundancy Check) character is used as the control information and is transmitted to the second segment after the end of the message. Thus, no transmission delay is created in a coupling device by generating control information for the respectively received message and comparing it with the control information received in the message as well as generating new control information for the transmitted message.

An acceptable compromise between reliable error detection and the additional amount of data that must be transmitted has proven to be a 5-bit CRC character. Such a CRC character may be used to advantage particularly in a PROFIBUS DP type field bus.

To ensure reliable end of message detection in the receiver, the message may simply be supplemented by an additional stop bit, which is directly followed by the control information. This makes it possible to eliminate a transmission pause between message and control information, and little additional transmission time is required for the expansion of the message by the control information.

If the receiver of the message is a coupling device which generates control information for a message received on the second segment, compares the generated control information with the received control information, and indicates an error if the two do not match, it may be readily read off the receiver whether the message was correctly transmitted via the corresponding segment. This may be indicated by optical means, e.g., an LED, or by electrical means, e.g., in that a signal is applied to an electrical contact wired with a control and observation station. Alternatively, an error reporting message may be generated, which is transmitted via the network to a central reporting station. This presumes, however, that the coupling device itself is authorized to access the network and is addressable in the network.

Permanent blocking of the forwarding of messages via a coupling device may be avoided in case of sporadic errors in that the block is removed if a check of the transmission quality on the second segment by special messages transmitted via the second segment from the first coupling device to the second coupling device and vice versa reveals that the transmission quality is good.

### BRIEF DESCRIPTION OF THE DRAWINGS

The invention as well as embodiments and advantages thereof will now be described in greater detail, by way of example, with reference to the drawings in which,

FIG. 1 is a network with electrical signal transmission on three segments,

FIG. 2 is a detail of a network with partly electrical and partly optical signal transmission,

FIG. 3 is a message structure with appended CRC character,

FIG. 4 is a block diagram of a coupling device,

FIG. 5 is a block diagram of a channel of a coupling device,

FIG. 6 is a flow diagram of the decoupling of a segment,

FIG. 7 is a flow diagram of the coupling of a segment with transmission of special messages, and

FIG. 8 is a network with the structure of an optical double ring.

### DETAILED DESCRIPTION OF THE PREFERRED EMBODIMENTS

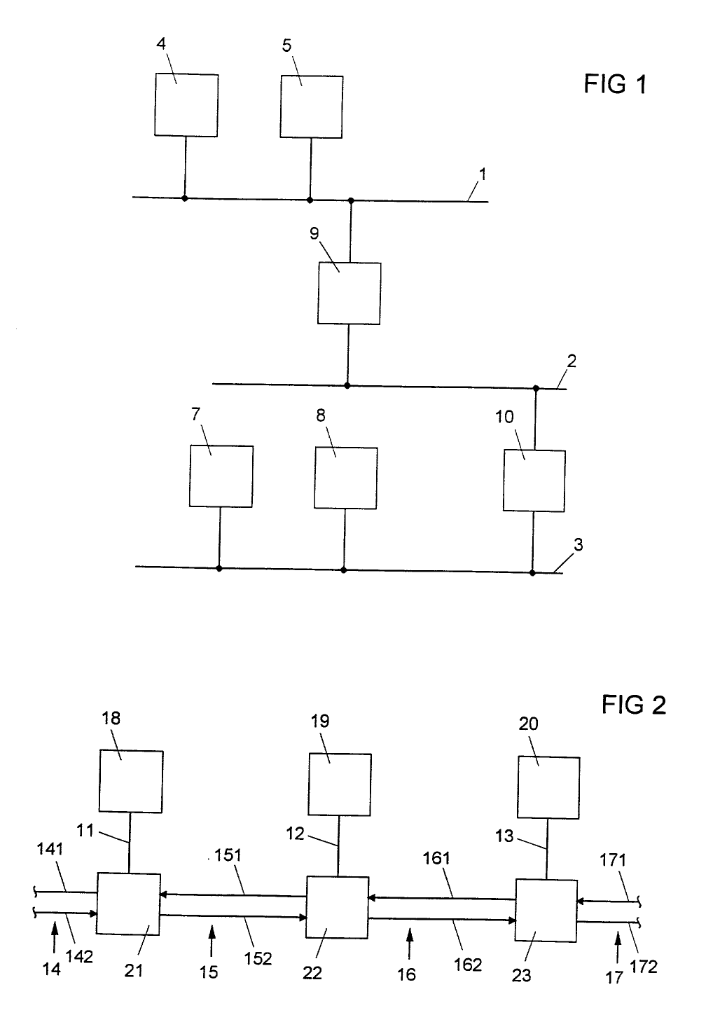

The network according to FIG. 1 is divided into three segments, 1, 2 and 3. Users 4 and 5 are connected to segment 1 and users 7 and 8 to segment 3. Segments 1 and 2 are interconnected by a repeater 9 as a first coupling device, while segments 2 and 3 are interconnected by a repeater 10 as a second coupling device. On segments 1 and 3 data is transmitted using the PROFIBUS DP protocol. Messages to be transmitted from segment 1 to segment 3 are provided with a CRC character in the first coupling device 9. To check correct transmission of the message via segment 2, this CRC character is read as control information in the second coupling device 10 and compared with a CRC character generated by means of the received message. The second coupling device 10 then forwards the message without the control information used in segment 2 to segment 3 which uses the PROFIBUS DP protocol. For the sake of clarity FIG. 1 shows a network with only three segments. In practice, however, networks have often a substantially larger number of segments, so that the possibility of error localization down to the faulty segment is a significant advantage. In the coupling devices 9 and 10 only two channels are required for segments with electrical signal transmission, so that other channels of the coupling devices can be switched off.

The network according to FIG. 2 contains segments 11, 12 and 13 on which data is transmitted with electrical signals, as well as segments 14, 15, 16, 17 with optical transmission. Only a detail of the network is shown. On segments 14 and 17, there may be additional coupling devices or users, which are not shown for the sake of clarity. Users 18, 19 and 20 are connected by segments 11, 12 or 13, respectively, with coupling devices 21, 22 or 23. Segments 14, 15, 16 and 17 with optical signal transmission have one optical fiber for each transmission direction. For segment 14, these are optical fibers 141 and 142, for segment 15, optical fibers 151 and 152, for segment 16, optical fibers 161 and 162 and for segment 17 optical fibers 171 and 172. The segments 11, 12 and 13 in this example are built in accordance with the RS485 specification and the data is transmitted using the PROFIBUS DP protocol. For data transmission security, only a parity bit is therefore used on segments 11, 12 and 13. The messages transmitted on segments 14, 15, 16 and 17 are each supplemented by a 5-bit CRC character.

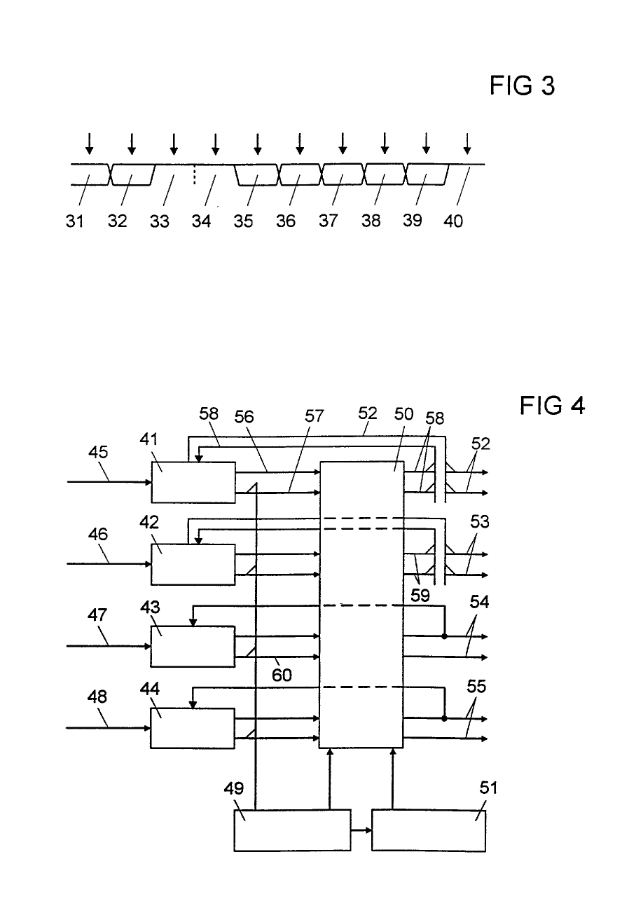

FIG. 3 shows the structure of a message with an appended CRC character, such as it may be used in the networks according to FIGS. 2 and 3. The control character is added to the message to detect dynamic errors, e.g., intermittent contact on an optical connector, a cold soldering joint, or excessively high attenuation of an optical fiber, and to obtain unambiguous localization of the fault location. This measure is used to check the transmission of a message from one coupling device to another, which represents the next receiver of the message. In the embodiment shown in FIG. 2, a CRC character is generated only for segments 14, 15, 16 and 17 with optical signal transmission and is checked in the respectively next recipient. If a received CRC character does not match a CRC character generated in a coupling device an error counter is increased by one, if it matches the error counter is decreased by one. When the error counter has reached a predefined limit value, preferably a value of 4, the forwarding of messages from the faulty segment to neighboring segments is blocked. In contrast, on segments 11, 12 and 13 with electrical signal transmission according to the RS485 specification, no CRC character is appended to the messages. Consequently, no deviation from the PROFIBUS DP protocol is required on these segments.

FIG. 3 shows only the last three bits, two data bits 31 and 32 and a stop bit 33, of a message that corresponds to the PROFIBUS DP protocol. To stop bit 33 a further stop bit 34 is appended, which is followed by five bits 35 . . . 39 of a CRC character. Downward pointing arrows above the individual bits indicate the scanning instants at which the signal value is scanned in the receiver. After the last bit 39, an idle state occurs corresponding to the indicated level 40 for the

In fault-free messages, the message end can be determined through a TLU (message length unit). In faulty messages, in a message using the PROFIBUS DP protocol, this may possibly be excluded due to the fault. To make it possible that the appended CRC character can be evaluated in any case and is not misinterpreted as a part of the faulty message, the message end must be reliably detected even in case of faults. In the example shown, an additional stop bit is therefore inserted between the end of the message according to the PROFIBUS DP protocol and the beginning of the CRC character. By means of these two stop bits 33 and 34 the receiver can thus detect the message end of any message, including a faulty message. The message end is detected in that the last character is not followed by a new start bit but by an additional stop bit.

The CRC character is always appended synchronously to the message character. Consequently, a started character is supplemented to eleven bit times even in case of faults so that the eleven bit character grid of a message is simulated.

As early as eleven bit times after the end of an error-free message, a reply message may already appear on the same segment. To prevent the receiver of a coupling device from being triggered by the CRC character to receive an eleven bit character, a receiving block is implemented, which prevents a restart of an RXD machine for the duration of the CRC character after each message end.

FIG. 4 shows the rough structure of the coupling devices 21, 22 and 23 of FIG. 2. For each segment that is connected to the coupling device, one channel is provided. The two channels 41 and 42 are designed for optical signal transmission while channels 43 and 44 are configured for electrical signal transmission on the respective segment. In the example according to FIG. 2 the coupling device 22, for instance, is wired in such a way that the signals of the optical fiber 152 of segment 15 are transmitted via transceivers (not depicted) with lines 45 to channel 41, the signals of optical fiber 161 of segment 16 via transceivers (not depicted) with lines 46 to the channel 42, and the electrical lines of segment 12 via transceivers (not depicted) with lines 47 to channel 43. Channel 44 is not used and may be disconnected separately from the remaining channels 41, 42 and 43 to reduce energy consumption. In this example, no segment is connected to lines 48 of channel 44. Path control 49 and a switching matrix 50 ensure the distribution of a received message to the connected segments. At any instant, they activate only one of channels 41 . . . 44, which remains selected until the end of the message. This is the case even if signals are simultaneously received on several channels. In channels 43 and 44, which are designed for electrical signal transmission, a received signal is forwarded on all segments except the segment that is connected with the currently active receive channel. In channels 41 and 42 for optical signal transmission, parameterization may be used to determine whether a received signal should, in addition, be returned on the segment of the currently active receive channel. Returning the received message on the segment of the currently active receive channel corresponds to forming an echo. As long as the data rate of the message has not yet been detected, path control 49 prevents the forwarding of received signals to the connected segments. Via transceivers (not depicted in FIG. 4), for instance in coupling device 22 of FIG. 2, optical fiber 151 of segment 15, optical fiber 162 of segment 16, and the electric lines of segment 12 (see FIG. 2) are connected, respectively, to lines 52, 53 and 54. There is no segment on lines 55. The signals transmitted on lines 45 . . . 48 are typically named RXD. Lines 52 . . . 55 each consist physically of at least two electrical lines provided for a TXD or RTS signal. To monitor echoes in channels 41 and 42, lines 58 or 59 are returned from the output of the switching matrix 50 to channels 41 or 42. The signals on lines 58 and 59 are evaluated in channels 41 or 42 and then possibly transmitted to lines 52 or 53.

By means of the example of a message received on segment 12 with electrical signal transmission, the functioning of path control 49 and switching matrix 50 will now be described. Path control 49, by means of a RTS signal that is supplied by channel 43 on a line 60 and is generated due to the receive signal on line 47 of channel 43, detects that a message is being received by segment 12. The switching matrix 50 is then adjusted by path control 49 such that the received message is routed to lines 58 and 59. Since no echo formation is set for segment 12 with electrical signal transmission, the message is not forwarded to lines 54. In channels 41 and 42 a character identifying the message is stored and the message is output on lines 52 or 53 to the connected segments 15 or 16. When the echo, which is generated by the neighboring coupling device 21 of the message that is output to lines 52, is received via lines 45 of channel 41, it is identified as an echo of this message by means of the stored message identification character and is no longer output by channel 41 to lines 56 and 57. Analogously, the echo generated by the neighboring coupling device 23 is removed from the network.

Through slot time determination 51, the pause between a transmitted message and receipt of a reply message may be determined.

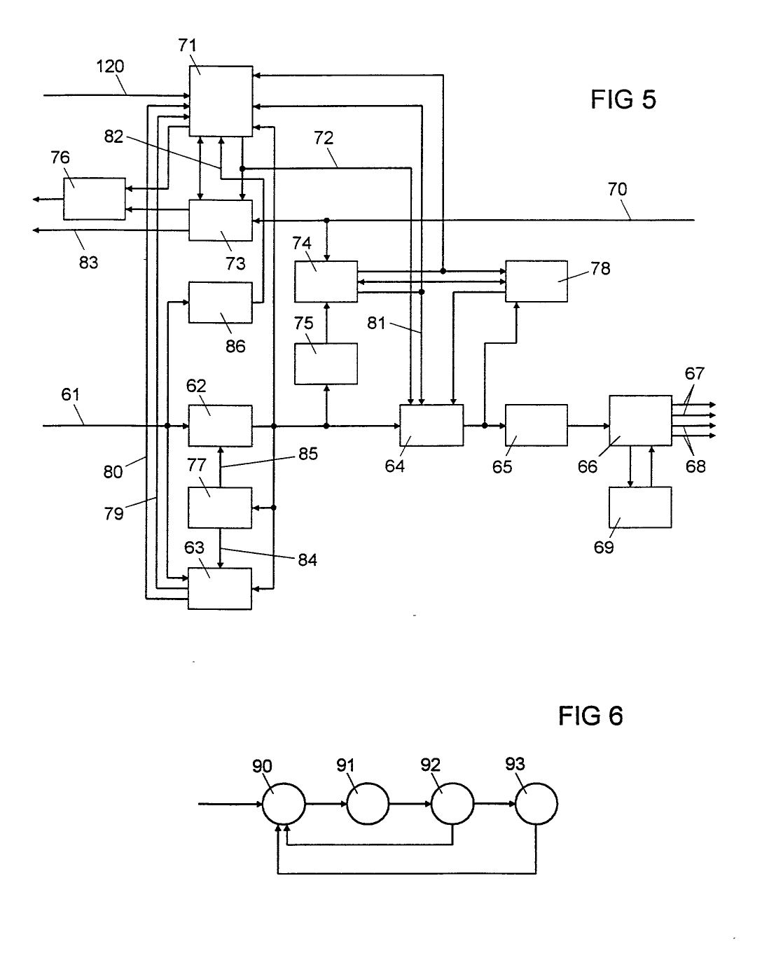

FIG. 5 shows a block diagram of channels 41 and 42 of FIG. 4. A line 61 supplies a received signal of a connected segment to a so-called RXD machine 62 and a CRC check 63. Based on the example of channel 41 of FIG. 4, line 61 corresponds to one of lines 45 in FIG. 4. Via a switch 64 and a first-in/first-out (FIFO) memory 65 the signal regenerated by the RXD machine 62 is supplied to a so-called TXD machine 66 which generates on the one hand a RTS and a TXD signal on lines 67 and on the other hand a RTS and TXD signal on lines 68. Lines 67 and 68 in the block diagram of FIG. 4 based on the example of channel 41 are connected as lines 56 or 57 to switching matrix 50. A message to which a CRC character is appended by a CRC generator 69 is output on lines 67. On lines 68 the message is forwarded without CRC character, so that the received message is output without change and is compatible with a transmission protocol of the users connected to the corresponding segment. In this example, lines 68 are used to forward the received message to segments with electrical signal transmission. For echo monitoring, i.e., to monitor the forwarding of a received message to the segment of the currently active receive channel, lines 70 are provided which, for instance in channel 41 of FIG. 4, are connected with lines 58 to which the switching matrix 50 routes the received message. The output of an AND gate 76 in the example of channel 41 of FIG. 4 is connected with lines 52 to transmit the TXD signal. A line 83 routes an RTS signal directly from a switch 73 to lines 52. Segmentation logic 71 controls blocking of the forwarding of faulty messages to the connected segments and, to this end, supplies a blocking signal on a line 72 to switch 73 and switch 64.

Further function blocks in FIG. 5 are a device 74 for the message start test, a delay element 75, a device 77 for message length determination (TLU), a device 86 for an activity check and a device 78 for ring monitoring, the function of which will be described in greater detail below.

Channels 43 and 44 are in principle configured similarly to channels 41 and 42. Eliminated, however, are CRC check 63, switch 73 and parts of segmentation logic 71 since a CRC character and an exchange of special messages do not occur on the segments with electrical signal transmission according to the PROFIBUS DP protocol.

The principal functioning of a coupling device will now be described by means of the example of coupling device 22 of FIG. 2. A message received, for instance, on segment 15 with optical signal transmission is first routed to the RXD machine 62. RXD machine 62, FIFO memory 65, and TXD machine 66 together have the function of a retimer so that any distortions in the received message are not propagated in the network. In the receiving branch of a channel in which a CRC character is expected as control information, the received message is in addition sent to CRC check 63 (FIG. 5) which generates a CRC character for the received message and compares it with the received CRC character. Device 77 for message length determination evaluates the start delimiter of the received message and determines the message length. It supplies a signal each to CRC check 63 and RXD machine 62 on lines 84 and 85, respectively, indicating the message end. Thus, CRC check 63 detects that only a stop bit 34 (FIG. 3) and the CRC character follow, and it reads the CRC character appended to the received message, which it requires for comparison with the self-generated CRC character. When the comparison has been executed, the received CRC character is discarded. Depending on the result of the comparison, CRC check 63 outputs an error signal on a line 79 or an OK message on a line 80 to segmentation logic 71. If switches 64 and 73 are closed and the received message is looped-through via switching matrix 50 (FIG. 4) with lines 58 to lines 70 (FIG. 5), channel 41 via lines 52 on optical fiber 151 of segment 15, which is provided for data transmission in the opposite direction, returns the received message with a CRC character newly generated in the CRC generator 69 as control information. In the activated receive channel of coupling device 21, which receives the echo message, the CRC character is again checked to detect any faults in the optical fiber 151 of the opposite transmission direction. In the receive channel of the coupling device 21 switch 64 is open, so that the received echo message does not interfere with the simultaneous transmission process. If the transmission on segment 15 was fault-free, the new CRC character matches the discarded CRC character, otherwise there is no match. The message is also sent to the remaining outputs of the coupling device, either with or without added CRC character as a function of the respective protocol of the connected segment, depending on the adjustment of the switching matrix 50 by path control 49 in which the transmission directions can be predefined. In the example shown in FIG. 2, a message supplemented by the CRC character is sent to segment 16 and a message without the additional CRC character to segment 12.

Through switches 64 and 73 in the channels of a coupling device, a faulty segment may furthermore be decoupled from the network as a measure of error handling so that faults do not affect the entire network. The fault can thus be advantageously localized to the faulty segment of the network.

In segments 14 . . . 17 depicted with optical signal transmission in FIG. 2, the transmission and receive paths are separately configured. If a segment is decoupled, i.e., if the forwarding of messages from a faulty segment via a coupling device to other segments connected to the coupling device is interrupted, both transmission directions are advantageously blocked. In case of a fault in segment 15, for example, after decoupling of this segment, no messages from segment 15 are thus transmitted to segments 12 or 16, and no messages from segments 12 or 16 to segment 15. This is particularly advantageous if the last of the segments with optical signal transmission in a series of cascaded segments of a so-called optical line is faulty. In the description of this advantage, it should be imagined that the example of FIG. 2 is modified in that segment 17 is absent and segment 16 is thus the last segment of the optical line. If a fault occurs in the obtained network structure in optical fiber 162 of segment 16, the forwarding of messages received on segment 16 to segment 13 is blocked. An active user 20 on segment 13 using the PROFIBUS DP protocol for data transmission no longer receives any messages. In multi-master operation using the PROFIBUS DP protocol, a master that no longer detects any activities in the network starts to send a token to itself and to poll other users in the network. This is referred to as continuous token sending. If despite blocking of the transmission direction from segment 16 to segment 13, the forwarding of messages in the opposite direction, i.e., from segment 13 to segment 16, were to remain open, the token and query messages of user 20 as master would be supplied to the entire network. In addition, these messages would be asynchronous to the messages of the rest of the network and would destroy those messages. In the extreme case, data transmission on the fault-free portion of the network would become impossible. To prevent this, both transmission directions are advantageously blocked simultaneously when a segment with optical signal transmission is decoupled. Both transmission directions are unblocked again only after bidirectional functionality of the segment has been determined by the exchange of special messages via the decoupled segment.

On segments 11, 12 and 13 with electrical signal transmission, the two transmission directions cannot be operated independently from one another since only a single transmission medium capable of bidirectional transmission is used. The case where transmission is faulty in one direction but not in the other is therefore extremely rare in practice. Both transmission directions are therefore not simultaneously blocked on segments 11, 12 and 13. For example, despite blocking of the forwarding of received messages on segment 12 with electrical signal transmission, coupling device 22 can continue to send messages to the faulty segment 12 without having to fear a blockage of the network. This has the advantage that, for instance, a passive user 19 who is connected to the network via a faulty segment 12 with electrical signal transmission and transmits his messages only as reply messages to previous poll messages, may continue to listen in on the poll messages. In a simultaneous blocking of both transmission directions of segment 12 by coupling device 22, passive users 19 would no longer receive any poll messages and consequently no longer send any reply messages. This user could then no longer be reached in the network. Due to the decoupling of segment 12 the forwarding of messages received on segment 12 to the network is blocked. But the poll messages in the network reach the passive user 19 nevertheless, and coupling device 22 can advantageously evaluate his reply messages to assess the transmission quality on segment 12. The exchange of special messages to determine the elimination of a fault is therefore unnecessary, and segment 12 is already recoupled if fault-free messages are received on segment 12 with electrical signal transmission. This procedure is advantageously also used in the other segments 11 and 13 with electrical signal transmission.

A sporadic fault, for instance on segment 12, thus results in a decoupling of the segment for only a few messages and does not cut a passive user off from the network for a prolonged period. As a result, the segmentation duration is better adapted to the type of the fault: in a sporadic fault the segment is already recoupled after a short time, whereas in a massive fault, e.g., a cable break, the segment is permanently decoupled.

The FIFO memory 65 in FIG. 5 serves to compensate bit time fluctuations which may occur during data transmission, for instance, due to crystal inaccuracies. If four bits are written into the FIFO memory 65, the FIFO memory starts to output the first bit. The memory depth of the FIFO memory 65 is nine bits.

The TXD machine 66 reads the bits stored in the FIFO memory 65 rigidly at intervals of one bit time. The RTS (request to send) signal controls the data flow direction of the transceiver of the respective channel and becomes active four bit times prior to the first start bit of the message. With the end of the last stop bit, the TXD machine 66 switches the RTS signal to inactive again.

Ring monitor 78 comprises a number of monitoring mechanisms that detect and eliminate circling messages, message fragments, or interference in an interconnection of coupling devices to an optical single fiber ring or an optical double ring, by interrupting the ring. An optical single fiber ring is, for instance, the network structure shown in FIG. 2, which exists due to echo formation, e.g., on segment 16 with connected coupling devices 22 and 23. An optical double ring is obtained by connecting optical fibers 141 and 142 of segment 14 with optical fibers 171 or 172 of segment 17.

One monitoring mechanism implemented in ring monitor 78 is a low-bit monitor that outputs an error signal if the data signal remains at the active level, here the low level, for 13 consecutive bit times. Such a character can never occur in valid message characters due to the high-level stop bit. Possible causes of such a fault are, for instance, light coupled in from an external source or a defective coupling device.

A further monitoring mechanism is a transmission time monitor, which outputs an error signal if more than 262 characters are counted in a message. The PROFIBUS DP protocol limits a message to a maximum of 255 characters, so that a message with more than 262 characters can occur only in the event of a fault. Possible causes are a defective active user on the corresponding segment or dynamic interference on the segment.

In addition, a start bit and message-length check is executed as a further monitoring mechanism. A counter is increased by two if an invalid start delimiter, or a valid start delimiter with a non-matching message length, is detected. With each fault-free message received the counter is decreased by one until it is back to zero again. The start bit and message-length check outputs an error signal if the counter exceeds a predefined number. This makes it possible to detect errors in which the message was corrupted by a defective user or by interference.

A repeat error test as a further monitoring mechanism is intended to prevent a formally valid message from permanently circling in an optical single fiber ring if device 74 for the message start test is no longer able to remove the message from the optical single fiber ring. The repeat error test contains a counter, which is increased by one if the second character of a message that has just been received matches that of the preceding message, or if a single character message is received. In the absence of a match the counter is set to zero, also if a message is newly supplied to the monitored single fiber ring. In the latter case device 74 is also active for the message start test. The repeat error test also outputs an error signal if the counter exceeds a predefined number. The repeat error test detects, for instance, interference coupled into an open optical fiber or into the transceivers.

Switch 64 interrupts the forwarding of received messages for echo filtering and is triggered by device 74 for the message start test with a signal on a line 81. In case of an error detected by ring monitor 78, switch 64 can also be opened by ring monitor 78. Only while the segment is idle in both the transmit and the receive direction, switch 64 is closed again.

All monitoring mechanisms may be activated singly or in combination by parameterization.

In an interconnection of coupling devices to form an optical ring, each optical channel must remove again the messages it supplied to the ring to prevent continuously circling messages. Device 74 for the message start test therefore remembers one character of up to 32 messages sent, which allows the optical channel to recognize again the messages it supplied to the optical ring and to remove them from the ring by opening switch 64 as described above. The received messages are continuously compared with the sent message starts, which are already stored in device 74 for the message start test. If the received message start matches the oldest entry, that entry is deleted. If the message start does not match the oldest entry but one of the more recent entries, it is assumed that the older messages had been faulty. In this case, the matching entries and all older entries are deleted. Device 74 for the message start test blocks the forwarding of received messages by opening switch 64 until all entries have been deleted and the end of the message, whose start matches the last entry, is reached. If more than 32 entries should be stored in device 74 for the message start test, device 74 reports an overflow to ring monitor 78. Ring monitor 78 then interrupts the sending and receiving of messages on the optical channel for one round-trip propagation delay.

Delay element 75, in which a shift register is located, delays the received messages after RXD machine 62 so that they arrive at device 74 for the message start test only when an identification of the original message, of which the received message is the echo, has been registered via line 70 in device 74 for the message start test. Device 74 can thus adhere to the same sequence in all cases: first send a message and store the identification of the message, then wait for the echo and detect it as the echo by means of the identification.

Device 86 for an activity check monitors the activities on the connected segment. If no bus activity is detected for a predefined period, this fact is reported by a signal via line 82 to segmentation logic 71 which then triggers the decoupling of the respective segment. Monitoring is effected by a counter, which is reset with each signal change on line 61 and otherwise counts continuously. If a predefined counter reading is exceeded the message signal is output to segmentation logic 71 and the counter is reset. When determining the predefined time period, the maximum possible signal propagation time within the network between the bus users that are the most remote from one another must be taken into account to avoid limiting the extent of the network by too small a time threshold.

Each of the following events can thus trigger the decoupling of a segment:

A received CRC character is not adapted to the received message or a stop bit error occurs in a received message character,

the optical signal level in the optical fiber has fallen below a minimum value; this is reported to segmentation logic 71 by a level measuring device through a signal 120,

the memory provided in device 74 for the message start test overflows at more than 32 messages that have been sent without receiving a valid echo, receive line 61 detects no activity for a predefined monitoring time, or a monitoring mechanism of ring monitor 78 detects errors in a received message.

The basic sequence of segment decoupling will now be described with reference to the flow diagram of FIG. 6 by means of the example of a fault in segment 15 in FIG. 2. After a reset, the sequence control is in a basic state 90 in which switch 64 is closed. If an event triggers the decoupling of a segment, the sequence control first quits the basic state 90 and passes to a wait state 91 in which switch 64 is opened and the forwarding of received messages to connected segments 12 and 16 is blocked. An error is indicated, but no error is reported yet via the signaling contact.

In the wait state 91, there is a wait for a predefined minimum segmentation time, which is preferably greater than the time threshold of a timer in the activity check device, which monitors transmission pauses on the connected segment and triggers segment decoupling if they are exceeded. This ensures that the neighboring coupling device (in the example according to FIG. 2 coupling device 21 which neighbors coupling device 22) has also triggered segment decoupling, i.e., is also blocking the forwarding of messages received by segment 15 to the other connected segments 11 and 14, before special messages are exchanged in a state 92 to check segment 15. These special messages are generated in segmentation logic 71 (FIG. 5) and are sent via AND gate 76 and a transceiver (not depicted) to segment 15. State 92 is referred to as first check. The longer the waiting period in state 91, the lower the influence of low-frequency dynamic interference in the network. On the other hand, in linear segments with cascaded coupling devices, the waiting period determines the minimum time for which the line is interrupted after a fault.

When segment 15 is decoupled, switches 64 and 73 are open. Thus, no echo is formed and the forwarding of received messages is blocked. RXD machine 62, device 77 for determining the message length, and CRC check 63 remain active, however, to evaluate the transmission quality by means of received messages and to inform segmentation logic 71 of the result of this evaluation via lines 79 and 80.

In wait state 91 there is already a response to special messages received, and the wait state 91 is quit to be able to respond to special messages of the neighboring coupling device 21, which itself is already in the first check state 92. After receipt of a special message, there is a wait for 22 bit times, which corresponds to observing the minimum message interval of eleven bit times and to terminating any previously started characters, before the first special message is sent in the first check state 92.

As described above, one cause of segment decoupling may be that a timer for monitoring transmission activities on the segment has exceeded a predefined maximum idle time. Possible causes are again a break in the optical fiber or a failure of the neighboring coupling device. A further reason for triggering this time-out circuit is the power-down of all active users in the network. The decoupled segment can therefore be OK or not OK when the maximum idle period is exceeded. Prior to issuing an error report, the corresponding segment is therefore checked by exchanging special messages in the first check state 92. If this first attempt to exchange special messages without error fails, the coupling devices connected to the segment change to a cyclic check state 93 in which they cyclically attempt to transmit special messages and at the same time activate an LED and a signaling contact for error indication. The signaling contact may be wired to a control and observation station to generate an error message. This measure makes it possible automatically to visualize a fault. If the special messages are transmitted without error in both directions, there is a switch to the basic state 90 and segment 15 is automatically recoupled to the network. The special messages realize a handshake procedure, which simultaneously ensures the lifting of the blocks in both coupling devices 21 and 22 on segment 15. This advantageously prevents that only a single transmission direction is activated at certain times. The segment thus permits bidirectional transmission immediately after recoupling. If that segment has no data traffic thereafter, the timer monitoring the maximum idle time is triggered again and special messages are exchanged again without an error message being issued. The exchange of special messages in the first check state 92 is indicated by a blinking light-emitting diode and thus serves as a status display as long as there is no data traffic on segment 15. In contrast, in the cyclic check state 93 an error is displayed by a continuously lit light-emitting diode and an error report is sent via the signaling contact. In this state the segment remains decoupled. At predefined cyclical intervals, special messages are sent to the faulty segment in the cyclic check state 93 and a check is executed. If the special messages are correctly transmitted, there is a change from the cyclic check state 93 to the basic state 90 and the error report is cancelled. To realize the handshake procedure with special messages, two special messages ST1 and ST2 were introduced, which are cyclically transmitted until the segment is recoupled. The special messages differ from useful messages transmitted in the network, so that they cannot be interpreted as useful messages. In addition, the special messages use a parity bit for the message characters with reversed polarity compared to the parity bit of useful messages. The special message ST1 serves for the cyclical introduction of a segment check, while the special message ST2 is sent as confirmation of correct message transmission. The special messages are provided with a CRC character to check the transmission quality.

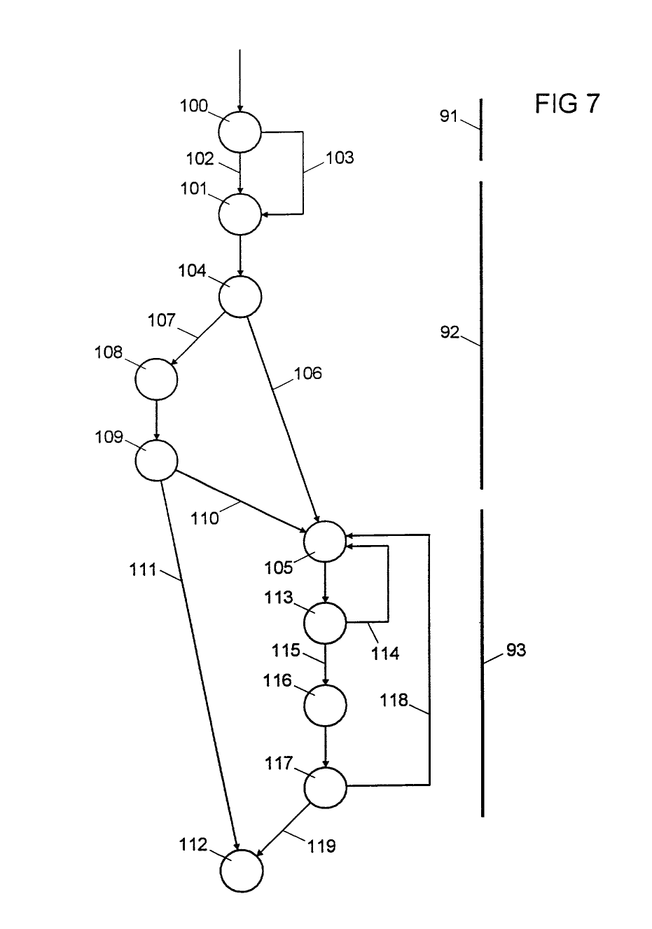

The flow diagram of FIG. 7 illustrates the procedure of segment coupling with transmission of special messages. The vertical lines on the right side of FIG. 7 mark the vertical regions corresponding to the wait state 91, the first check state 92 and the cyclic check state 93 in FIG. 6.

After decoupling of a segment, there is a switch to state 100 in which a timer is started to monitor a minimum segmentation time. When the timer has expired, there is a change to state 101 and a special message ST1 is sent. The expiration of the timer is marked by a change-of-state arrow 102. As indicated by arrow 103, state 101 is also entered when a special message ST1 or ST2 was received. After sending a special message ST1 in state 101, the timer for monitoring the minimum segmentation time is reset and is restarted when there is a change to state 104. If the neighboring coupling device on the segment receives no special message ST1 or ST2 until the timer expires, there is a change to state 105 as indicated by arrow 106 and a special message ST1 is again transmitted. On the other hand, if prior to expiration of the timer a special message ST1 is received in state 104, a change to state 108 takes place, as indicated by arrow 107, in which a special message ST2 is transmitted. The timer is then reset and is restarted in a subsequent state 109. If in state 109 no reply message to the sent special message ST2 is received from the neighboring coupling device as the timer expires, a change to state 105 takes place, as indicated by arrow 110, which represents the start of the cyclic check. If, however, a special message ST2 sent by a neighboring coupling device is received within the monitoring time, this means that the receive and send paths of the segment are OK. As indicated by arrow 111 a change to state 112 takes place in which the segment is recoupled, i.e., the forwarding of received messages to neighboring segments is unblocked. In state 105, which was assumed after expiration of the timer, the coupling device again sends a special message ST1 to the faulty segment. A cycle timer is then reset and there is a change to state 113 in which the expiration of the cycle timer is monitored. The monitoring time of the cycle timer determines the cycle time at which special messages are sent to the segment. If the cycle time has expired without a special message having been received, a change to state 105 takes place as indicated by arrow 114. If, however, a special message ST1 sent by a neighboring coupling device was received, there is a change to state 116, as indicated by arrow 115, in which a special message ST2 is sent to the neighboring coupling device. Thereafter, the cycle timer is reset and in a state 117 the expiration of the cycle timer is again monitored. If the cycle timer expires without a special message ST2 having been received, a return to state 105 takes place as indicated by arrow 118. Receipt of a special message ST2 by a neighboring coupling device in state 117 means that the receive and transmit paths of the segment are OK again. As indicated by arrow 119, there is a change to state 112 in which the cycle check is terminated and the segment is recoupled. State 112 corresponds to the basic state 90 of FIG. 6.

The described handshake procedure with special messages ST1 and ST2 automatically and simply recouples a faulty segment after the fault has been eliminated.

Segments that must satisfy a certain protocol, for instance the PROFIBUS DP protocol, which does not permit any special messages, are unblocked without such a handshake procedure. In the example of FIG. 2, segments 11, 12 and 13 are this type of segments. Here the coupling device again decouples the faulty segment in the event of an error, that is, it blocks the forwarding of messages received on a respectively faulty segment 11, 12 or 13. The FIFO memory of the retimer is erased. After a parameterizable minimum segmentation time has elapsed, a monitoring timer and a message counter are started. When the segment is decoupled, transmission to the faulty segment remains unblocked to prevent the formation of partial networks, which-as described above-could result, for instance, in double token formation. The forwarding of received messages, for example, on segments 15 or 16 to segment 12 thus continues even if segment 12 is faulty, independent of whether the forwarding of messages is blocked in the opposite direction. Monitoring mechanisms check the received signal of the faulty segment. With each signal received the monitoring timer is reset and restarted. If no further messages are received within the monitoring time, presumably no users are connected to the segment and the response was to a temporary interference. The segment can therefore be recoupled. If prior to expiration of the monitoring time a predefined number of error-free messages was consecutively received, the segment is recoupled as soon as the segment is in an idle state in transmit and receive direction.

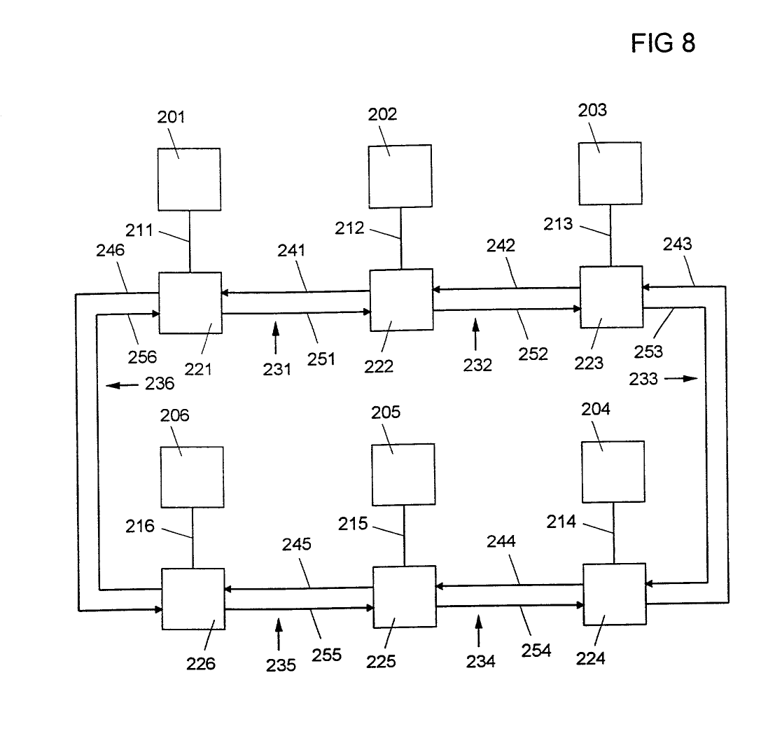

With reference to the example of FIG. 8, a possibility for obtaining increased network availability by interconnecting the components to an optical double ring will now be described. In the network shown, users 201 . . . 206 are each connected by segments 211 . . . 216 with electrical signal transmission on which data is transmitted using the PROFIBUS DP protocol to coupling devices 221 . . . 226. The coupling devices 221 . . . 226 are interconnected in pairs by segments 231 . . . 236 with optical signal transmission so that an optical double ring is created as depicted in FIG. 8. Segments 231 . . . 236 for each transmission direction have optical fibers 241 . . . 246 respectively optical fibers 251 . . . 256, which can be operated independently from one another. The coupling devices 221 . . . 226 monitor segments 211 . . . 216 as well as 231 . . . 236 for faults and decouple faulty segments as described above with reference to the network shown in FIG. 2. When a faulty segment is decoupled, for instance, segment 236 in FIG. 8, an optical line is created from the original optical double ring in which users 201 . . . 206 can continue to be reached. This increases the availability of the network. By exchanging special messages between the coupling devices, in the example of a faulty segment 236 between the coupling devices 221 and 226, an elimination of the fault is detected, as described above, and segment 236 is recoupled to the network after elimination of the fault. Thus, after the fault has been eliminated, the optical line is closed again to form an optical double ring.

The functional principle of the optical double ring is that the coupling device simultaneously forwards messages that are supplied by a user via a segment with electrical signal transmission to both connected segments with optical signal transmission. For instance, a message sent by user 201 via segment 211 to coupling device 221 is forwarded by coupling device 221 through optical fiber 251 of segment 231 to coupling device 222 and through optical fiber 246 of segment 236 to coupling device 226. Thus, the message sent by user 201 is duplicated. The two circulating messages, which are completely identical, are subsequently detected as identical messages by coupling device 224, where they meet as a function of the propagation time, and are removed from the optical double ring. Device 74 (see FIG. 5) for the message start test, which stores a character to identify the sent messages in order to prevent permanently circling messages, as described above, is used for this purpose. The described mechanisms remove the messages circulating in opposite direction from the optical double ring even if the two messages meet in a segment with optical signal transmission, i.e., not directly at a coupling device.

If segment 236 was decoupled due to faults by coupling devices 221 and 226, a message of user 201 is merely forwarded by coupling device 221 to segment 231 and is not duplicated. Prior to recoupling a faulty segment with optical signal transmission it may furthermore, occur that out of the two identical messages circulating in the optical double ring in opposite direction, some may be deleted on the coupling device, which blocks the forwarding of messages to the faulty segment, while the messages with a longer propagation time to the coupling device opposite of the faulty segment are still underway. In this case the balance of identical messages circulating in opposite directions is disturbed. Recoupling a faulty segment after elimination of the fault during an imbalance of circulating messages could create circling messages in the optical double ring, which could be detected and eliminated, but until their elimination would interfere with the entire network.

An easy-to-use possibility to avoid the creation of such circling messages is to unblock a segment after elimination of the fault at a time when no messages are in transit in the network. In a network with users that use the PROFIBUS DP protocol to process their data traffic, this state is certainly present shortly after an active user addressed a so-called GAP query to a user that does not exist in the network. In PROFIBUS DP, active users execute GAP queries to check cyclically whether new users have been connected to the network and want to participate in the data traffic. With each GAP query the interrogating user waits for a reply with which the new user will indicate his presence if he has meanwhile been connected to the network. If the interrogating user does not receive a reply within a predefined time, the so-called slot time, he assumes that the queried user cannot be reached in the network. The slot time is dimensioned so that it is greater than the longest possible time delay between query and reply message. It results from the sum of the propagation times of the query message to the queried user and the reply message to the interrogating user between the respectively most remote users plus a reply delay of the queried user and a safety margin.

The coupling devices 221 . . . 226 require information on the extent of the network for certain monitoring mechanisms, e.g., to determine the monitoring time in device 86 (see FIG. 5) for the activity check. One possibility to provide the coupling devices with this information would be a parameterization via the network. This possibility would be connected with high costs, however, since the coupling device would have to appear as an independent addressable user when the network is configured. A further possibility would be to make the extent of the network manually adjustable or readable in the coupling devices. This possibility would be subject to errors, however, and connected with high costs when the network is installed. The extent of the network could also be preset through a default value in the coupling devices. But this default value would have to be designed for the maximum permissible network extent and, in the corresponding application in a network, would have to be unnecessarily high.

Advantageously, the coupling devices 221 . . . 226 measure the slot time during operation of the network. The slot time contains information on the extent of the network so that costly parameterization of the coupling devices regarding the network extent may be eliminated. The slot time T, is parameterized in the users as follows:

[See source for equation]

with

Tₛ—slot time,

T_{SM}—a safety margin,

L_{ges}—sum of the lengths of the segments with optical signal transmission,

N_{K}—number of coupling devices,

V_{K}—signal propagation time through a coupling device,

Tsdx —maximum delay time after which a polled user must reply to a poll message, and

T_{Bit}—the time of one bit at the correspondingly set data rate.

The slot time is thus configured in such a way that it is at least twice as large than would actually be necessary for the extent of the network. The slot time is then also greater than the maximum delay in an optical line into which the optical double ring of FIG. 8 is split if, for instance, a fault is determined on segment 236, and segment 236 is decoupled.

To ensure that no messages are circulating in the network when a previously blocked segment is unblocked again after elimination of the fault, the involved coupling devices must wait for a GAP query of an active user and thereafter for the expiration of half the slot time. After a GAP query message has been received, it is necessary to wait for half the slot time, since in a GAP query to a user present in the network, that user's reply message would reach the coupling device prior to expiration of half the slot time.

If after a GAP query no reply message is received at the coupling device within half the slot time, the GAP query must have been addressed to a non-existing user and it is therefore certain that no messages are in transit in the network. This procedure prevents circling messages in the optical double ring when segments are recoupled after the fault has been eliminated.

Since the coupling devices 221 . . . 226 can measure the slot time only in GAP queries of active users to users that are not present in the network, the HSA (Highest Station Address) of the active users is configured in such a way that during operation GAP queries are directed to at least one non-existent user. To ensure that the slot time is determined exclusively by means of such GAP queries, the measurements are made only between two poll messages with acknowledge or between a poll message with acknowledge and a token message. To ensure automatic adaptation of the measured slot times in case of changes in the network, or to permit the correction of wrong measurements, the slot time measurements are made continuously during operation. The measurement is made by a slot time counter which counts the number of bit times between the message end of a poll message with acknowledge and the message start of the following message. The determined slot time is stored in a slot time flag in slot time determination 51 (see FIG. 4). After a restart of the network, the slot time flag in the coupling devices is set to a default value as the initial value, which corresponds to the highest settable value. After each valid measurement the slot time flag is overwritten with the new measured value.

Active users are users that are located in the logic token ring of the network and thus can accept the token and pass it to the next active user in the logic token ring. The corresponding token holder is authorized to transmit in the network. In contrast, passive users cannot accept the token. They send merely reply messages when a token holder requests them to do so through a poll message.

The above description of the preferred embodiments has been given by way of example. From the disclosure given, those skilled in the art will not only understand the present invention and its attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed is:

1. A network with a plurality of users, which is divided into several segments interconnected by at least one coupling device, characterized in that the at least one coupling device has means for measuring the predefined slot time in the users by means of so-called GAP queries with which the active users using the PROFIBUS DP protocol for data transmission cyclically check whether new users have been connected to the network, wherein the slot time is the time for which an active user waits after a GAP query for a reply message from a polled user.

2. The network as claimed in claim 1, characterized in that at least one active user is configured in such a way that it executes cyclical GAP queries to a non-existent user.

3. The network as claimed in claim 1, characterized in that the slot time predefined in the users is at least twice the time that elapses at maximum in an optical double ring between sending a GAP query message and receiving a reply message.

4. The network as claimed in claim 1, characterized in that the network is divided into at least three segments with bidirectional data transmission, wherein a first segment and a second segment are interconnected by a first coupling device, and wherein the second segment and a third segment are interconnected by a second coupling device, that the first coupling device has means for detecting any corruption of a message through faults on the second segment and after detection of a fault to block the forwarding to the first segment of messages received in the second segment, and that the second coupling device has means to block the forwarding to the third segment of messages received in the second segment upon detection of a block of the forwarding of messages by the first coupling device.

5. The network as claimed in claim 4, characterized in that the first coupling device has means for blocking the forwarding of messages to the second segment upon detection of a fault in the second segment for at least a predefined time, the so-called minimum segmentation time, that the second coupling device has a device for monitoring transmission activities on the second segment, which checks compliance with a maximum idle time on the second segment, which preferably is half the measured slot time, and if the maximum idle time is exceeded, blocks the forwarding to the third segment of messages received on the second segment, and that the minimum segmentation time is greater than the maximum idle time.

6. The network as claimed in claim 4, characterized in that forwarding by the first coupling device is blocked only after determination of a predefined number of errors.

7. The network as claimed in claim 4, characterized in that the means for detecting message corruption are configured such that an error is detected if a signal level in a received message persists longer than a predefined time.

8. The network as claimed in claim 7, characterized in that an error is detected if in a received message the signal level remains on a low level for 13 consecutive bit times.

9. The network as claimed in claim 4, characterized in that the means for detecting message corruption are configured such that an error is detected if more than a predefined number of characters are contained in a received message.

10. The network as claimed in claim 9, characterized in that an error is detected if more than 262 characters are contained in a received message.

11. The network as claimed in claim 4, characterized in that the second coupling device has means for supplementing a message to be forwarded from the third segment to the second segment, irrespective of possibly present control information valid on the third segment, by control information valid on the second segment, which is adapted to the message sent on the second segment, so that the first coupling device connected to the second segment can evaluate the control information to assess the transmission quality on the second segment.

12. The network as claimed in claim 11, characterized in that the first coupling device has means for generating control information for a message received on the second segment, comparing the generated control information with the received control information, and indicating an error in case of a mismatch between the two.

13. The network as claimed in claim 12, characterized in that the first coupling device has means for blocking the forwarding to the third segment of the messages received on the second segment in case of a mismatch between the two.

14. The network as claimed in claim 11, characterized in that the control information is a CRC (Cyclic Redundancy Check) character.

15. The network as claimed in claim 14, characterized in that the CRC character comprises 5 bits.

16. The network as claimed in claim 14, characterized in that the second coupling device has means for supplementing the message by an additional stop bit and sending the control information immediately after the additional stop bit.

17. The network as claimed in claim 4, characterized in that the second coupling device has means for unblocking the forwarding if a check of the transmission quality on the second segment by special messages transmitted via the second segment from the first coupling device to the second coupling device and vice versa shows good transmission quality.

18. The network as claimed in claim 17, characterized in that the first and the second coupling device have means for performing a handshake procedure to check the transmission quality on the second segment by special messages in which,
(a) the first coupling device, after expiration of the minimum segmentation time, sends a first special message (ST1) via the second segment to the second coupling device;
(b) the second coupling device in case of error-free receipt of the first special message (ST1) returns a second special message (ST1) via the second segment to the first coupling device,
(c) the first coupling device in case of error-free receipt of the second special message (ST1) sends a third special message (ST2) via the second segment to the second coupling device, and
(d) the second coupling device in case of error-free receipt of the third special message (ST2) returns a fourth special message (ST2) via the second segment to the first coupling device, and
that means are present for reinitiating the handshake procedure if the time between sending a first special message and receiving a returned second special message is greater than a predefined maximum time.

19. A coupling device for connecting two segments in a network as claimed in claim 1, characterized in that the coupling device has means for measuring the predefined slot time in the users by means of so-called GAP queries with which active users using the PROFIBUS DP protocol for data transmission cyclically check whether new users have been connected to the network, wherein the slot time is the time for which an active user waits after a GAP query for a reply message from a polled user.

20. A network with a plurality of users, which is divided into at least three segments with bidirectional data transmission, wherein a first segment and a second segment are interconnected by a first coupling device and wherein the second segment and a third segment are interconnected by a second coupling device, and the first coupling device has means for detecting corruption of a message through faults on the second segment and, after detection of an error, blocking the forwarding of messages received on the second segment to the first segment, characterized in that the second coupling device has means for blocking the forwarding of messages received on the second segment to the third segment upon detection of a block of the forwarding of messages by the first coupling device.

21. The network as claimed in claim 20, characterized in that the first coupling device has means for blocking the forwarding of messages to the second segment for a predefined time, the so-called minimum segmentation time, upon detection of a fault on the second segment, that the second coupling device has means for monitoring the transmission activities on the second segment, which checks compliance with a predefined maximum idle time on the second segment, and if said maximum idle time is exceeded, blocks the forwarding of messages received on the second segment to the third segment, and that said minimum segmentation time is greater than the maximum idle time.

22. The network as claimed in claim 20, characterized in that the forwarding by the first coupling device is blocked only after a predefined number of errors has been ascertained.

23. The network as claimed in claim 20, characterized in that the means for detecting message corruption are configured such that an error is detected if a signal level in a received message persists longer than a predefined time.

24. The network as claimed in claim 23, characterized in that an error is detected if in a received message the signal level remains on a low level for 13 consecutive bit times.

25. The network as claimed in claim 20, characterized in that the means for detecting message corruption are configured such that an error is detected if more than a predefined number of characters are contained in a received message.

26. The network as claimed in claim 25, characterized in that an error is detected if more than 262 characters are contained in a received message.

27. The network as claimed in claim 20, characterized in that the second coupling device has means for supplementing a message to be forwarded from the third segment to the second segment, irrespective of possibly present control information valid on the third segment, by control information valid on the second segment, which is adapted to the message sent on the second segment, so that the first coupling device connected to the second segment can evaluate the control information to assess the transmission quality on the second segment.

28. The network as claimed in claim 27, characterized in that the first coupling device has means for generating control information for a message received on the second segment, comparing the generated control information with the received control information, and indicating an error in case of a mismatch between the two.

29. The network as claimed in claim 28, characterized in that the first coupling device has means for blocking the forwarding to the third segment of the messages received on the second segment in case of a mismatch between the two.

30. The network as claimed in claim 27, characterized in that the control information is a CRC (Cyclic Redundancy Check) character.

31. The network as claimed in claim 30, characterized in that the CRC character comprises 5 bits.

32. The network as claimed in claim 30, characterized in that the second coupling device has means for supplementing the message by an additional stop bit and sending the control information immediately after the additional stop bit.

33. The network as claimed in claim 20, characterized in that the second coupling device has means for unblocking the forwarding if a check of the transmission quality on the second segment by special messages transmitted via the second segment from the first coupling device to the second coupling device and vice versa shows good transmission quality.

34. The network as claimed in claim 33, characterized in that the first and the second coupling device have means for performing a handshake procedure to check the transmission quality on the second segment by special messages in which,
(a) the first coupling device, after expiration of the minimum segmentation time, sends a first special message (ST1) via the second segment to the second coupling device;
(b) the second coupling device in case of error-free receipt of the first special message (ST1) returns a second special message (ST1) via the second segment to the first coupling device,
(c) the first coupling device in case of error-free receipt of the second special message (ST1) sends a third special message (ST2) via the second segment to the second coupling device, and
(d) the second coupling device in case of error-free receipt of the third special message (ST2) returns a fourth special message (ST2) via the second segment to the first coupling device, and
that means are present for reinitiating the handshake procedure if the time between sending a first special message and receiving a returned second special message is greater than a predefined maximum time.

35. The coupling device for connecting two segments in a network as claimed in claim 20, wherein the coupling device has means for detecting corruption of the message by faults on the second segment and, after detection of an error, blocking the forwarding of messages received on the second segment to the first segment, characterized in that the coupling device has means for blocking the forwarding of messages to the second segment for a predefined time, the so-called minimum segmentation time, upon detection of an error on the second segment, that the coupling device has means for monitoring the transmission activities on the second segment, which checks compliance with a predefined maximum idle time on the second segment and, if said maximum idle time is exceeded, blocks the forwarding of messages received on the second segment to the first segment and the second segment, and that the minimum segmentation time is greater than the maximum idle time.
